(19) United States
(12) Patent Application Publication
(10) Pub. No.: US 2025/0080839 A1
(43) Pub. Date: Mar. 6, 2025

(54) ON-DEMAND PHASE DETECTION AUTOFOCUS (PDAF)

(71) Applicant: QUALCOMM Incorporated, San Diego, CA (US)

(72) Inventors: Micha Galor Gluskin, San Diego, CA (US); Oscar Keh-Farn Lin, San Diego, CA (US)

(21) Appl. No.: 18/462,230

(22) Filed: Sep. 6, 2023

(51) Int. Cl. H04N 23/67; H04N 23/71; H04N 23/743

(52) U.S. Cl. CPC H04N 23/672; H04N 23/675; H04N 23/71; H04N 23/743

(57) ABSTRACT

A system includes one or more memories configured to store a camera image captured with a camera; and processing circuitry in communication with the one or more memories. The processing circuitry is configured to identify, in the camera image, a first camera image portion and a second camera image portion, apply primary phase detection autofocus (PDAF) to the first camera image portion, and apply the primary PDAF and secondary PDAF to the second camera image portion. Additionally, the processing circuitry is configured to control, based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.

### TECHNICAL FIELD

The disclosure relates to capture or image processing.

### BACKGROUND

A camera device includes one or more cameras that capture frames (e.g., images). Examples of the camera device include stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, gaming devices, computer devices that include cameras, such as so-called “web-cams,” smartwatch, a device equipped with own camera, a device configured to control another device equipped with a camera, or any device with digital imaging or video capabilities. A camera device processes the captured frames and outputs the frames for display. In some examples, the camera device controls the exposure, focus, and white balance to capture high quality images.

In some examples, a camera may use phase detection autofocus (PDAF) techniques to automatically bring one or more objects into focus. PDAF involves processing camera data to identify whether an image is out of focus. When an image is out of focus, a camera may use PDAF to automatically control a focus of the camera. For example, a camera may adjust a distance between one or more camera lenses and a camera sensor to adjust a focus of the camera.

### SUMMARY

In general, this disclosure describes techniques for performing phase detection autofocus (PDAF) in a way that conserves computing resources by using specialized image processing for portions (e.g., only for portions) of camera images that cannot be sufficiently processed using a primary PDAF image processing technique. A system may apply the primary PDAF image processing to a camera image. But in some cases, the primary PDAF image processing is insufficient for processing one or more portions of the camera image. The system may, when primary PDAF image processing is insufficient, apply secondary PDAF image processing to sufficiently process the one or more portions of the camera image that would not have been sufficiently processed with the primary PDAF. This may ensure that the system uses computing resources beyond resources for performing primary PDAF image processing only when primary PDAF image processing produces an insufficient result.

In some examples, primary PDAF image processing may include using a hardware horizontal image processing unit to perform horizontal PDAF image processing. For example, a system may use a hardware horizontal image processing unit to apply horizontal PDAF image processing to camera images. In some examples, horizontal PDAF image processing might not be sufficient for processing some regions of a camera image. The system may apply vertical PDAF image processing to regions of camera images that are not sufficiently focused using horizontal image processing. In some examples, the system may use a hardware vertical image processing unit to perform vertical PDAF image processing. In some examples, the system may use software and/or one or more machine learning models to perform vertical PDAF image processing.

Some camera images may be generated using multiple exposure. For example, a camera image may include a long exposure component and a short exposure component. In some examples, primary PDAF image processing may include using a hardware unit to perform horizontal PDAF image processing on the long exposure component of a camera image. But in some cases, using the hardware unit to perform horizontal PDAF image processing on the long exposure component of a camera image may be insufficient for processing the camera image. The system may use software, executing on processing circuitry, to process the short exposure component based on use of the hardware unit to perform horizontal PDAF image processing on the long exposure component being insufficient.

The techniques of this disclosure may result in more efficient use of computing resources for PDAF image processing as compared with other systems that perform PDAF image processing. For example, by applying primary PDAF image processing and using secondary PDAF image processing only when necessary to achieve a sufficient result, the system may reduce an amount of computing resources necessary for camera focusing as compared with systems that do not process data based on whether secondary resources are necessary. Reducing the amount of computing resources necessary for camera focusing may reduce an amount of time required to process the camera images. Additionally, or alternatively, reducing the amount of computing resources necessary for camera focusing may reduce an amount of energy drawn by circuitry to process the camera images.

In one example, a system includes one or more memories configured to store a camera image captured with a camera; and processing circuitry in communication with the one or more memories. The processing circuitry is configured to identify, in the camera image, a first camera image portion and a second camera image portion, apply PDAF to the first camera image portion, and apply the primary PDAF and secondary PDAF to the second camera image portion. Additionally, the processing circuitry is configured to control, based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.

In another example, a method includes identifying, in a camera image, a first camera image portion and a second camera image portion, applying PDAF to the first camera image portion, and applying the primary PDAF and secondary PDAF to the second camera image portion. The method also includes controlling, based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.

In another example, a computer-readable medium stores instructions that, when applied by processing circuitry, cause the processing circuitry to: identify, in a camera image, a first camera image portion and a second camera image portion, apply primary PDAF to the first camera image portion, and apply the primary PDAF and secondary PDAF to the second camera image portion; and The instructions also cause the processing circuitry to control, based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.

The summary is intended to provide an overview of the subject matter described in this disclosure. It is not intended to provide an exclusive or exhaustive explanation of the systems, device, and methods described in detail within the accompanying drawings and description below. Further details of one or more examples of this disclosure are set forth in the accompanying drawings and in the description below. Other features, objects, and advantages will be apparent from the description and drawings, and from the claims.

### BRIEF DESCRIPTION OF DRAWINGS

FIG. 1 is a block diagram of a camera system configured to perform one or more of the example techniques described in this disclosure.

FIG. 2 is a block diagram illustrating the camera, the camera processor, the central processing unit (CPU), and the system memory of the camera system of FIG. 1 in further detail.

FIG. 3A is a conceptual diagram illustrating a first camera image including a first object and a first image region, in accordance with one or more techniques of this disclosure.

FIG. 3B is a conceptual diagram illustrating a second camera image including a second object and a second image region, in accordance with one or more techniques of this disclosure.

FIG. 4A is a conceptual diagram illustrating a long exposure component of a camera image including a region of interest (ROI), in accordance with one or more techniques of this disclosure.

FIG. 4B is a conceptual diagram illustrating a short exposure component of a camera image including an ROI, in accordance with one or more techniques of this disclosure.

FIG. 5 is a flow diagram illustrating an example method for processing a camera image to focus a camera, in accordance with one or more techniques of this disclosure.

### DETAILED DESCRIPTION

The example techniques described in this disclosure relate to camera focus (e.g., depth where a camera should focus for image or video capture). Phase detection autofocus (PDAF) image processing is one technique for achieving fast and accurate autofocus in capturing sharp features of camera images. In some examples, systems may use PDAF in capturing moving objects, or processing complex scenes having depth variation where fast focusing is beneficial. That is, it may be beneficial to decrease an amount of time that it takes for a system to use PDAF in order to decrease an amount of time that it takes to focus the camera.

A camera may, in some examples, include a lens that refracts rays of light and a sensor that generates image data based on capturing the rays of light. Focusing a camera may involve adjusting a position of the lens of the camera relative to the sensor of the camera so that rays of light refracted by the lens converge precisely on the sensor of the camera. When rays of light do not converge in the proper location on the sensor, the resulting camera image may appear out of focus. Out of focus images may include objects and/or backgrounds that are blurry. Camera users may, in some examples, focus a camera manually. Additionally, or alternatively, a camera may use one or more autofocus techniques to automatically focus the camera without input from the user and based on image data collected by the camera.

PDAF is one autofocus technique that relies on detecting phase differences between incoming light rays refracted by the lens of a camera and captured by two sets of phase-detecting photodiodes. Phase differences between incoming light rays respectively captured by the two sets of phase-detecting photodiodes may, in some examples, indicate an extent to which image content is out of focus. Phase differences may additionally or alternatively indicate a direction in which the camera should be focused to bring one or more subjects into focus. For example, phase differences may indicate whether the lens should be moved closer to the sensor to bring an image into focus or whether the lens should be moved further away from the sensor to bring the image into focus.

A camera that is configured for PDAF may include a device for splitting incoming light rays into two or more separate paths so that each set of phase-detecting photodiodes receive respective light rays. A camera sensor may include phase detection photodiodes (e.g., pixels) that are configured to detect the phase of the light rays of the two or more separate paths. A camera processor may calculate a phase difference between the light rays of the two or more separate paths. The phase difference may indicate an extent to which the camera is out of focus and a direction that the position of the lens should be adjusted to bring the camera into focus. The camera may, based on the calculated phase difference, adjust the lens relative to the sensor to bring the camera into focus.

PDAF may, in some examples, be performed horizontally and/or vertically. Horizontal PDAF may focus a camera image in a way that is sensitive to phase differences moving across the image horizontally. That is, a camera performing horizontal PDAF may effectively focus a scene where an object having a first depth is separated from a background having a second depth by a substantially vertical boundary. But horizontal PDAF might less effectively bring into focus a scene where an object having a first depth is separated from a background having a second depth by a substantially horizontal boundary. This is because a processor performing horizontal PDAF might bring into focus images having texture including variations along a horizontal axis more effectively than the processor brings into focus images having texture that does not include variations along a horizontal axis. Vertical boundaries may introduce variations in image texture along a horizontal axis and horizontal boundaries may introduce variations in image texture along a vertical axis.

In some examples, a camera system may use horizontal PDAF to autofocus a camera. But in some cases, horizontal PDAF might be insufficient for bringing one or more portions of a camera image into focus. For the one or more portions of the camera image that are not sufficiently focused using horizontal PDAF, the system may use vertical PDAF to bring the one or more regions into focus. In some cases, vertical PDAF may help to focus some portions of the camera image that horizontal PDAF might not be able to effectively bring into focus. For example, when a region of a camera image includes substantially horizontal texture feature that are not easily identified by processing data from left to right or from right to left, vertical PDAF may be useful for bringing these horizontal texture features into focus.

A camera system described herein may use “on-demand” PDAF to initially process a camera image using a primary PDAF technique, and process portions of a camera image using a secondary PDAF technique when the primary PDAF technique is insufficient for bringing one or more portions of a camera image into focus. In some cases, the camera system may use the secondary PDAF technique based on a confidence value associated with the primary PDAF technique. The confidence value may indicate an extent to which the computing system is confident that the primary PDAF technique is sufficient. The secondary PDAF technique may, in some cases, use computing resources in addition to resources used for the primary PDAF technique. It may take time to apply the secondary PDAF technique in addition to the time that it takes to apply the primary PDAF technique. By using on-demand PDAF to apply the secondary PDAF technique only when the primary PDAF technique is not sufficient to bring one or more regions of a camera image into focus.

In some examples, a primary PDAF technique may include horizontal PDAF and a secondary PDAF technique may include vertical PDAF. That is, the camera system may process camera images using horizontal PDAF and process one or more regions of a camera image using vertical PDAF when horizontal PDAF is not sufficient for bringing the one or more regions into focus. This may allow the camera system to reserve using vertical PDAF only when necessary to bring certain regions of an image into focus, thus decreasing an amount of time necessary to bring an image into focus. In some examples, vertical PDAF may be performed using a hardware unit, software, or a combination of hardware and software.

Camera images may, in some examples, be captured using multiple exposure. That is, a long exposure component and a short exposure component may be combined to create a camera image. In some examples, a system may use hardware to perform a primary PDAF technique on the long exposure component of a camera image. When necessary, the system may use software to further process the short exposure component of the camera image according to a secondary PDAF technique. This is because using the hardware to perform PDAF on the long exposure component may yield insufficient results in some cases, and further processing the short exposure component may improve the focused image. Additionally, or alternatively, the system may use hardware to perform a primary PDAF technique on the short exposure component of a camera image. When necessary, the system may use software to further process the long exposure component of the camera image according to a secondary PDAF technique.

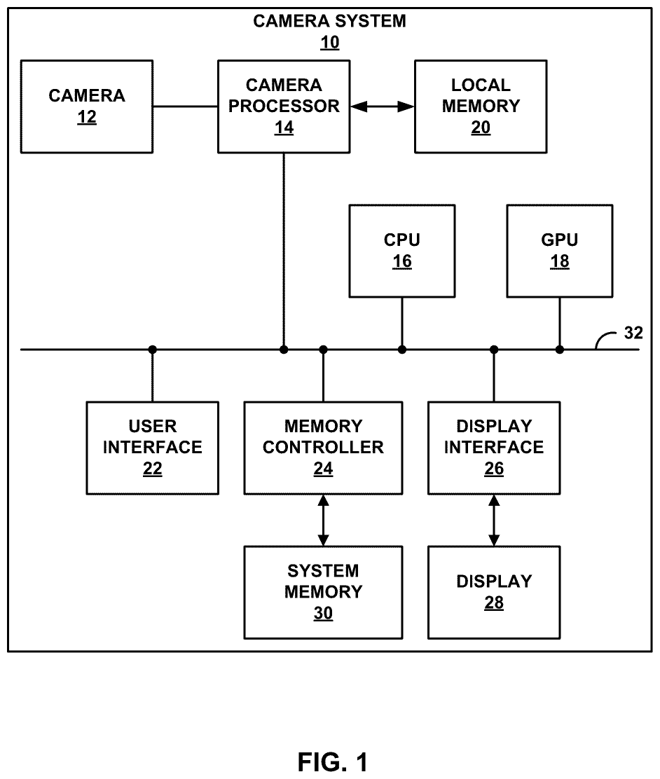

FIG. 1 is a block diagram of a camera system 10 configured to perform one or more of the example techniques described in this disclosure. Examples of camera system 10 include stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, watches, gaming devices, computer devices that include cameras, such as so-called “webcams,” or any device with digital imaging or video capabilities.

As illustrated in the example of FIG. 1, camera system 10 includes camera 12 (e.g., having an image sensor and lens), camera processor 14 and local memory 20 of camera processor 14, a central processing unit (CPU) 16, a graphical processing unit (GPU) 18, user interface 22, memory controller 24 that provides access to system memory 30, and display interface 26 that outputs signals that cause graphical data to be displayed on display 28. Although the example of FIG. 1 illustrates camera system 10 including one camera 12, in some examples, camera system 10 may include a plurality of cameras, such as for omnidirectional image or video capture.

Also, although the various components are illustrated as separate components, in some examples the components may be combined to form a system on chip (SoC). As an example, camera processor 14, CPU 16, GPU 18, and display interface 26 may be formed on a common integrated circuit (IC) chip. In some examples, one or more of camera processor 14, CPU 16, GPU 18, and display interface 26 may be in separate IC chips. Additional examples of components that may be configured to perform the example techniques include a digital signal processor (DSP), a vector processor, or other hardware blocks used for neural network (NN) computations. Various other permutations and combinations are possible, and the techniques should not be considered limited to the example illustrated in FIG. 1.

The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. Examples of local memory 20 and system memory 30 include one or more volatile or non-volatile memories or storage devices, such as random access memory (RAM), static RAM (SRAM), dynamic RAM (DRAM), erasable programmable ROM (EPROM), electrically erasable programmable ROM (EEPROM), flash memory, a magnetic data media or an optical storage media.

The various units illustrated in FIG. 1 communicate with each other using bus 32. Bus 32 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced extensible Interface (AXI) bus) or another type of bus or device interconnect. The specific configuration of buses and communication interfaces between the different components shown in FIG. 1 is merely exemplary, and other configurations of camera devices and/or other image processing systems with the same or different components may be used to implement the techniques of this disclosure.

Camera 12 may, in some examples, include a lens and a sensor. The lens may refract light onto the sensor, which generates one or more image frames for output. In some examples, the sensor corresponding to camera 12 may include image pixels that capture image data and phase detection pixels that are used for autofocus techniques such as PDAF. PDAF is a technique for achieving fast and accurate focus in capturing sharp images. For example, when one or more objects are moving in a 3D environment, or when one or more objects are located between a camera and a background, a camera using PDAF may bring the objects into focus more quickly and more efficiently as compared with objects that do not use PDAF to focus image data.

A sensor of camera 12 may include dedicated phase pixels that are separate from image pixels of the sensor of camera 12. Camera 12 may direct light rays to both of the phase pixels and image pixels. The image pixels may capture image data that forms camera images. Phase pixels may, in some examples, include pairs of pixels (e.g., pairs of “left” and “right” pixels and/or pairs of “up” and “down” pixels). The phase pixels may perform phase detection by detecting phase differences between the pixels each pair of pixels. Phase pixels may be part of the camera sensor hardware. PDAF hardware units for processing data collected by camera 12 may be separate from hardware of camera 12.

Camera system 10 may use hardware to perform PDAF. For example, PDAF hardware units that may process data captured by the phase pixels and/or image pixels of the sensor of camera 12 to perform PDAF. Camera system 10 may additionally or alternatively use software to perform PDAF. For example, system memory 30 may be configured to store PDAF software that is configured to process data collected by the sensor of camera 12 to perform PDAF. In some examples, system memory 30 may be configured to store one or more models (e.g., machine learning models, neural networks) configured to process data collected by the sensor of camera 12 to perform PDAF. In some examples, camera system 10 uses software to perform PDAF as a supplement to using hardware to perform PDAF.

In some examples, using software to perform PDAF consumes a greater amount of computing resources and/or consumes a greater amount of energy as compared with using dedicated hardware components (e.g., phase detection pixels and PDAF hardware units) to perform PDAF without using software. In some examples, using software to perform PDAF takes a greater amount of time as compared with using dedicated hardware components (e.g., phase detection pixels and PDAF hardware units) to perform PDAF without using software. Since it may be beneficial to perform PDAF quickly while conserving energy, computing device 10 may, in some examples, use hardware to perform PDAF and use software as a complement to hardware when hardware alone is insufficient for autofocusing.

Camera 12 may be configured to perform horizontal PDAF and/or vertical PDAF. When camera 12 is configured for horizontal PDAF, phase detection pixels may be arranged horizontally across a sensor of camera 12. In some examples, this means that pairs of phase detection pixels may include a “left” pixel and a “right” pixel arranged horizontally. Phase detection pixels arranged horizontally may be sensitive to horizontal phase differences between rays of light coming from different parts of the lens of camera 12. When camera 12 is configured for vertical PDAF, phase detection pixels may be arranged vertically across a sensor of camera 12. In some examples, this means that pairs of phase detection pixels may include an “up” pixel and a “down” pixel arranged vertically. Phase detection pixels arranged vertically may be sensitive to vertical phase differences between rays of light coming from different parts of the lens of camera 12.

In some examples, when camera system 10 performs horizontal PDAF, camera system 10 may effectively focus objects having substantially vertical and/or substantially diagonal lines relative to the camera sensor. Since camera system 10 processes data horizontally when performing horizontal PDAF, camera system 10 may be configured to easily identify vertical texture features because a phase may change moving horizontally across vertical texture features. In some examples, when camera system 10 performs vertical PDAF, camera system 10 may effectively focus objects having substantially horizontal and/or substantially diagonal lines relative to the camera sensor. Since camera system 10 processes data vertically when performing horizontal PDAF, camera system 10 may be configured to easily identify horizontal texture features because a phase may change when moving vertically across horizontal texture features.

Camera system 10 may, in some examples, use horizontal PDAF to process camera images collected by camera 12. In some examples, horizontal PDAF is sufficient for processing one or more regions of a camera images. But in some cases (e.g., where a region of a camera image includes one or more substantially horizontal lines), camera system 10 may use vertical PDAF processing to achieve a sufficient result. In some examples, camera system 10 may use hardware to perform horizontal PDAF and use software to perform vertical PDAF when horizontal PDAF is insufficient for processing a region of a camera image. In some examples, camera system 10 may use hardware to perform horizontal PDAF and use software to perform vertical PDAF when horizontal PDAF is insufficient for processing a region of a camera image.

Camera processor 14 is configured to receive image frames (or simply “images” or “camera images”) from camera 12, and process the images to generate output images for display. CPU 16, GPU 18, camera processor 14, or some other circuitry may be configured to process the output image that includes image content generated by camera processor 14 into images for display on display 28. In some examples, GPU 18 may be further configured to render graphics content on display 28.

In some examples, camera processor 14 may be configured as an image processing pipeline. For instance, camera processor 14 may include a camera interface that interfaces between camera 12 and camera processor 14. Camera processor 14 may include additional circuitry to process the image content. Camera processor 14 outputs the resulting images with image content (e.g., pixel values for each of the image pixels) to system memory 30 via memory controller 24. In some examples, camera processor 14 may include one or more PDAF hardware units configured to process image data and/or phase data collected by the sensor of camera 12. For example, camera processor 14 may include a horizontal PDAF hardware unit for performing horizontal PDAF and/or a vertical PDAF hardware unit for performing vertical PDAF.

Camera processor 14 may, in some examples, receive one or more camera images from camera 12 for processing. Additionally, or alternatively, camera processor 14 may receive one or more camera images from system memory 30 for processing. Camera processor 14 may be configured to, for each camera image of the one or more camera images, identify a first camera image portion and a second camera image portion. In some examples, camera processor 14 may be configured to sufficiently perform PDAF on the first portion of the camera image using horizontal PDAF without using vertical PDAF and/or sufficiently perform PDAF on the first portion of the camera image using hardware without using software. In some examples, camera processor 14 might not be configured to sufficiently perform PDAF on the second portion of the camera image using horizontal PDAF without using vertical PDAF and/or might not be configured to sufficiently perform PDAF on the first portion of the camera image using hardware without using software.

In some examples, camera processor 14 may apply horizontal PDAF to a first camera image portion to generate a first processed camera image portion. Applying horizontal PDAF may be sufficient for generating the first processed camera image portion to exceed a threshold level of PDAF quality without applying the vertical PDAF. That is, camera processor 14 may sufficiently process the first camera image portion by applying horizontal PDAF without needing to use additional computing resources and draw additional power to apply vertical PDAF to the first camera image portion. Camera processor 14 may sufficiently process the first camera image portion by applying horizontal PDAF without taking additional time to apply vertical PDAF to the first camera image portion.

In some examples, camera processor 14 may apply A PDAF hardware unit to a first camera image portion to generate a first processed camera image portion. Applying a PDAF hardware unit may be sufficient for generating the first processed camera image portion to exceed a threshold level of PDAF quality without applying software stored by system memory 30. That is, camera processor 14 may sufficiently process the first camera image portion by applying a PDAF hardware unit without needing to use additional computing resources and draw additional power to apply software to the first camera image portion. Camera processor 14 may sufficiently process the first camera image portion by applying the PDAF hardware unit without taking additional time to apply software stored by system memory 30 to the first camera image portion.

Camera processor 14 may, in some cases, apply both horizontal PDAF and vertical PDAF to the second camera image portion to generate a second processed camera image portion. That is, camera processor 14 may use vertical PDAF to process the second camera image portion when using horizontal PDAF alone does not produce a sufficient result. Camera processor 14 may, in some cases, use both hardware of camera processor 14 and software stored by system memory 30 to the second camera image portion to apply PDAF to generate a second processed camera image portion. That is, camera processor 14 may use software process the second camera image portion when using hardware alone does not produce a sufficient result.

CPU 16 may comprise a general-purpose or a special-purpose processor that controls operation of camera system 10. A user may provide input to camera system 10 to cause CPU 16 to execute one or more software applications. The software applications that execute on CPU 16 may include, for example, a media player application, a video game application, a graphical user interface application or another program. The user may provide input to camera system 10 via one or more input devices (not shown) such as a keyboard, a mouse, a microphone, a touch pad or another input device that is coupled to camera system 10 via user interface 22.

One example of the software application is a camera application. CPU 16 executes the camera application, and in response, the camera application causes CPU 16 to generate content that display 28 outputs. GPU 18 may be configured to process the content generated by CPU 16 for rendering on display 28. For instance, display 28 may output information such as light intensity, whether flash is enabled, and other such information. The user of camera system 10 may interface with display 28 to configure the manner in which the images are generated (e.g., with or without flash, focus settings, exposure settings, and other parameters).

As one example, after executing the camera application, camera system 10 may be considered to be in preview mode. In preview mode, camera 12 outputs image content to camera processor 14 that performs camera processing and outputs image content to system memory 30 that display interface 26 retrieves and outputs on display 28. In preview mode, the user, via display 28, can view the image content that will be captured when the user engages a button (real or on display) to take a picture. As another example, rather than taking a still image (e.g., picture), the user may record video content (e.g., a series of images). During the recording, the user may be able to view the image content being captured on display 28.

In this disclosure, a preview image may be referred to as an image that is generated in preview mode. For instance, in preview mode, the image that camera 12 outputs and stores (e.g., in local memory 20 or system memory 30) for processing by camera processor 14 or the image that camera processor 14 generates and stores (e.g., in local memory 20 or system memory 30) may be referred to as a preview image. In general, a preview image may be an image generated in preview mode prior to capture and long-term storage of the image.

During preview mode or recording, camera system 10 (e.g., via CPU 16) may control the way in which camera 12 captures images (e.g., before capture or storing of image). This disclosure describes the examples techniques as being performed by CPU 16. However, the example techniques should not be considered limited to CPU 16 performing the example techniques. For instance, CPU 16 in combination with camera processor 14, GPU 18, a DSP, a vector processor, and/or display interface 26 may be configured to perform the example techniques described in this disclosure. For example, one or more processors may be configured to perform the example techniques described in this disclosure. Examples of the one or more processors include camera processor 14, CPU 16, GPU 18, display interface 26, a DSP, a vector processor, or any combination of one or more of camera processor 14, CPU 16, GPU 18, display interface 26, the DSP, or the vector processor.

CPU 16 may be configured to control the exposure and/or focus to capture visually pleasing images. For example, CPU 16 may be configured to generate signals that control the exposure, focus, and white balance, as a few non-limiting examples, of camera 12. CPU 16 may be configured to control the exposure, focus, and white balance based on the preview images received from camera processor 14 during preview mode or recording. In this way, for still images, when the user engages to take the picture, the exposure, focus, and white balance are adjusted (e.g., the parameters for exposure, focus, and possibly white balance are determined before image capture so that the exposure, focus, and white balance can be corrected during the image capture). For recording, the exposure, focus, and white balance may be updated regularly during the recording.

Memory controller 24 facilitates the transfer of data going into and out of system memory 30. For example, memory controller 24 may receive memory read and write commands, and service such commands with respect to system memory 30 in order to provide memory services for the components in camera system 10. Memory controller 24 is communicatively coupled to system memory 30. Although memory controller 24 is illustrated in the example of camera system 10 of FIG. 1 as being a processing circuit that is separate from both CPU 16 and system memory 30, in other examples, some or all of the functionality of memory controller 24 may be implemented on one or both of CPU 16 and system memory 30.

System memory 30 may store program modules and/or instructions and/or data that are accessible by camera processor 14, CPU 16, and GPU 18. For example, system memory 30 may store user applications (e.g., instructions for the camera application), resulting frames from camera processor 14, etc. System memory 30 may additionally store information for use by and/or generated by other components of camera system 10. For example, system memory 30 may act as a device memory for camera processor 14.

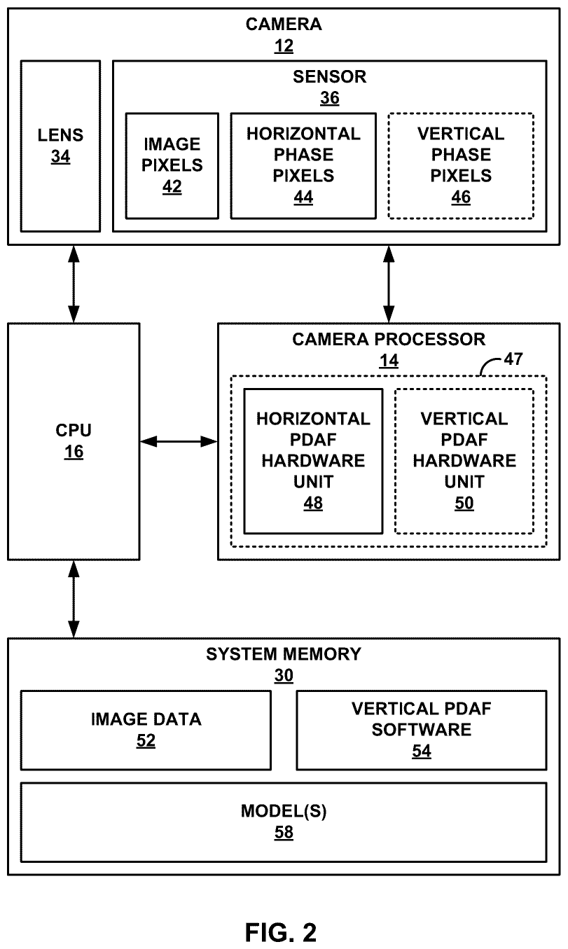

FIG. 2 is a block diagram illustrating the camera 12, the camera processor 14, the CPU 16, and the system memory 30 of the camera system of FIG. 1 in further detail. As illustrated in FIG. 2, camera 12 includes lens 34 and sensor 36. Sensor 36 includes image pixels 42, horizontal phase pixels 44, and vertical phase pixels 46. Camera processor 14 includes PDAF hardware 47 including horizontal PDAF hardware unit 48 and vertical PDAF hardware unit 50. In some examples, PDAF hardware 47 does not include vertical PDAF hardware unit 50 and includes horizontal PDAF hardware unit 48. System memory 30 is configured to store image data 52, vertical PDAF software 54, and model(s) 58.

Camera 12 may be configured to generate one or more camera images. For example, lens 34 of camera 12 may refract light onto image pixels 42 of sensor 36. Image pixels 42 may be configured to generate data (e.g., digital pixel data) comprising the one or more camera images. In some examples, digital pixel data may include color data and/or intensity data corresponding to each image pixel of image pixels 42. Sensor 36 of camera 12 may be configured, in some cases, to output the one or more camera images to processor 14. In some examples, sensor 36 may be configured to output one or more camera images to system memory 30 for storage as part of image data 52.

In some examples, sensor 36 may be configured to generate phase data corresponding to each camera image of the one or more camera images. For instance, sensor 36 may include two or more sets of photodiodes, and the phase difference in image content captured by the different sets of photodiodes is an example of the phase data. Phase data may be used to autofocus a camera. That is, based on phase data generated by sensor 36, camera system 10 may control a focus of lens 34 in order to bring one or more objects in image data generated by image pixels 42 into focus. In some examples, to control the focus of lens 34, camera system 10 may control a distance between lens 34 and sensor 36, control an angle of lens 34 with respect to sensor 36, or any combination thereof.

Sensor 36 may include horizontal phase pixels 44. Horizontal phase pixels 44 may, in some examples, be arranged horizontally across sensor 36. In some examples, horizontal phase pixels 44 may include one or more pairs of “left” and “right” pixels. That is, each pair of horizontal phase pixels may include a side-by-side pair including a left phase pixel and a right phase pixel. The one or more pairs of pixels of horizontal phase pixels 44 may be configured to detect horizontal phase differences between light rays refracted from different locations on lens 34. These phase differences may indicate differences between objects within a 3D environment. Using the phase data generated by horizontal phase pixels 44, camera system 10 may control a focus of camera 12 so that the objects within the 3D environment appear clearly and in focus in camera images generated by camera 12.

Sensor 36 may include vertical phase pixels 46. Vertical phase pixels 46 may, in some examples, be arranged vertically across sensor 36. In some examples, vertical phase pixels 46 may include one or more pairs of “up” and “down” pixels. That is, each pair of vertical phase pixels may include a pair including a first pixel above another pixel. The one or more pairs of pixels of vertical phase pixels 46 may be configured to detect vertical phase differences between light rays refracted from different locations on lens 34. These phase differences may indicate differences between objects within a 3D environment. Using the phase data generated by vertical phase pixels 46, camera system 10 may control a focus of camera 12 so that the objects within the 3D environment appear clearly and in focus in camera images generated by camera 12.

In some examples, one or more camera images generated by camera 12 may include image data generated by image pixels 42, phase data generated by horizontal phase pixels 44, phase data generated by vertical phase pixels 46, or any combination thereof. Camera processor 14 may be configured to process one or more camera images to autofocus camera 12 (e.g., apply PDAF). In some examples, it may be beneficial to quickly focus camera 12 so that camera 12 captures quality images of one or more objects within a 3D environment. In some examples, a focus of camera 12 for capturing quality images may depend on many factors including a location of one or more objects with respect to camera 12, a location of one or more objects with respect to a background, light levels of the 3D environment, or any combination thereof.

Camera processor 14 may, in some examples, be configured to use horizontal PDAF hardware unit 48 to process phase data collected by horizontal phase pixels 44 and/or image pixels 42 in order to autofocus camera 12. That is, camera processor 14 may apply horizontal PDAF hardware unit 48 to data generated by horizontal phase pixels 44 and/or image pixels 42 to generate an output. In some examples, using horizontal PDAF hardware unit 48 may be sufficient for autofocusing camera 12. In some examples, using horizontal PDAF hardware unit 48 might not be sufficient for autofocusing camera 12.

In some examples, camera processor 14 may identify a first camera image portion and a second camera image portion of a camera image generated by camera 12. Camera processor 14 may, in some examples, identify the first camera image portion as a portion of the camera image that camera processor 14 is configured to sufficiently process using horizontal PDAF hardware unit 48 (e.g., there can be sufficiently accurate autofocusing using horizontal PDAF hardware unit 48). Camera processor 14 may, in some examples, identify the first camera image portion as a portion of the camera image that camera processor 14 is configured to sufficiently process using any PDAF hardware unit. Camera processor 14 may, in some examples, identify the second camera image portion as a portion of the camera image that camera processor 14 is not configured to sufficiently process using horizontal PDAF hardware unit 48 (e.g., there may not be sufficiently accurate autofocusing using horizontal PDAF hardware unit 48). Camera processor 14 may, in some examples, identify the second camera image portion as a portion of the camera image that camera processor 14 is not configured to sufficiently process using any PDAF hardware unit 48.

In some examples, to identify the first camera image portion and the second camera image portion of a camera image generated by camera 12, camera processor 14 is configured to determine a set of confidence scores. Each confidence score of the set of confidence scores corresponds to an image region of a set of image regions of the camera image generated by camera 12. That is, camera processor 14 may generate a confidence score corresponding to each image region of the set of image regions of the camera image. In some examples, the confidence score corresponding to each image region of the set of image regions may represent a confidence that horizontal PDAF hardware unit 48 is configured to sufficiently process the image data corresponding to the respective image region.

Camera processor 14 may, in some cases, compare each confidence score of the set of confidence scores with a threshold confidence score. In some examples, camera processor 14 may identify the first camera image portion to include each image region of the set of image regions corresponding to a confidence score greater than the threshold confidence score. That is, the first camera image portion may include regions associated with high confidence in using horizontal PDAF hardware unit 48 and/or any PDAF hardware unit to process the regions to achieve a sufficient result. Camera processor 14 may identify the second camera image portion to include each image region of the set of image regions corresponding to a confidence score not greater than the threshold confidence score. That is, the first camera image portion may include regions associated with low confidence in using horizontal PDAF hardware unit 48 and/or any PDAF hardware unit to process the regions to achieve a sufficient result.

To determine a confidence score corresponding to each image region of a set of image regions, camera processor 14 may identify a sum of absolute differences (SAD) curve corresponding to each image region of the set of image regions. In some examples, the SAD curve corresponding to each image region of the set of image regions, camera processor 14 may calculate a SAD corresponding to the image region for each offset value of a set of offset values. For example, the camera processor 14 may calculate an SAD corresponding to the image region and the image region offset by n pixels, calculate an SAD corresponding to the image region and the image region offset by n−1 pixels, and so on. Camera processor 14 may determine each confidence score of the set of confidence scores based on the SAD curve corresponding to the respective image region. In some examples, processor 14 may identify SAD curves based on pixel data (e.g., color data, intensity data).

To determine each confidence score of the set of confidence scores based on the SAD curve corresponding to the respective image region, camera processor 14 is configured to identify a minimum value of the SAD curve corresponding to each image region of the set of image regions and calculate an average value of the SAD curve corresponding to each image region of the set of image regions. Camera processor 14 may calculate each confidence score of the set of confidence scores based on the minimum value of the SAD curve corresponding to the respective image region and based on the average value of the SAD curve corresponding to the respective image region.

For example, camera processor 14 may calculate each confidence score of the set of confidence scores to be a difference between the minimum value of the SAD curve corresponding to the respective image region and the average value of the SAD curve. In another example, camera processor 14 may calculate each confidence score of the set of confidence scores to be a ratio of the average value of the SAD curve corresponding to the respective image region to the minimum value of the SAD curve. In any case, when the minimum value of an SAD curve is closer to an average value of an SAD curve, a confidence score corresponding to the image region associated with the SAD curve may be lower as compared with when the minimum value of an SAD curve is further away from the average value of an SAD curve.

In some examples, camera processor 14 may use horizontal PDAF hardware unit 48 to process the first camera image portion identified by camera processor 14 and use horizontal PDAF hardware unit 48 to process the second camera image portion identified by camera processor 14. This means that even though horizontal PDAF hardware unit 48 may be sufficient to process the first camera portion and might not be sufficient to process the second camera portion, camera processor 14 may use the horizontal PDAF hardware unit 48 to process both of the first camera image portion and the second camera image portion. But since horizontal PDAF hardware unit 48 might not be sufficient for processing the second camera portion, camera processor 14 may supplement hardware based horizontal PDAF processing with one or more other kinds of PDAF processing to process the second camera portion.

For example, camera processor 14 may use vertical PDAF software 54 stored by system memory 30 to process the second camera portion. In some examples, camera processor 14 may use vertical PDAF software 54 stored by system memory 30 to process the second camera portion in addition to using horizontal PDAF hardware unit 48 to process the second camera portion. In some examples, camera processor 14 may use vertical PDAF software 54 stored by system memory 30 to process the second camera portion instead of using horizontal PDAF hardware unit 48 to process the second camera portion.

In some examples, using both horizontal PDAF hardware unit 48 and vertical PDAF software 54 to process the second camera image portion may consume a greater amount of computing resources and/or take a greater amount of time as compared with using horizontal PDAF hardware unit 48 to process the second camera image portion without using the horizontal PDAF hardware unit 48. In some examples, using vertical PDAF software 54 to process the second camera image portion may consume a greater amount of computing resources and/or take a greater amount of time as compared with using horizontal PDAF hardware unit 48 to process the second camera image portion. This means that it may be beneficial to use horizontal PDAF hardware unit 48 to process the second camera image portion without using vertical PDAF software 54.

Camera processor 14 may, in some cases, use model(s) 58 stored by system memory 30 to process the second camera portion. For example, camera processor 14 may use a vertical PDAF deep neural network (DNN) to process the camera image portion. In some examples, camera processor 14 may use model(s) 58 stored by system memory 30 to process the second camera portion in addition to using horizontal PDAF hardware unit 48 to process the second camera portion. In some examples, camera processor 14 may use model(s) 58 stored by system memory 30 to process the second camera portion instead of using horizontal PDAF hardware unit 48 to process the second camera portion.

Camera processor 14 may be configured to store vertical PDAF hardware unit 50. In some examples, vertical PDAF hardware unit 50 may process camera images output by camera 12. For example, vertical PDAF hardware unit 50 may process image data output from image pixels 42, phase data output from horizontal phase pixels 44, phase data output from vertical phase pixels 46, or any combination thereof. In some examples, camera processor 14 may use vertical PDAF hardware unit 50 to process one or more portions of a camera image that is not sufficiently processed using horizontal PDAF hardware unit 48. For example, camera processor 14 may use horizontal PDAF hardware unit 48 to process a first camera image portion and a second camera image portion. When a result of using horizontal PDAF hardware unit 48 to process a second camera image portion does not exceed a threshold quality level, camera processor 14 may use vertical PDAF hardware unit 50 to process the second camera image portion.

In some examples, camera 12 may capture one or more camera images using multiple exposure. In some examples, multiple exposure involves capturing multiple images using the same sensor to create a composite image. Some multiple exposure techniques involve capturing a long exposure component and a short exposure component and combining the long exposure component and the short exposure component into one camera image. For example, sensor 36 may capture a long exposure component and a short exposure component and generate a camera image based on the long exposure component and the short exposure component. In some examples, image pixels 42 are exposed to rays of light for a longer period of time for the long exposure component than image pixels 42 are exposed to rays of light for the short exposure component.

Camera processor 14 may, in some examples, process the long exposure component of a camera image using PDAF hardware 47. In some examples, camera processor 14 may process the long exposure component of a camera image using horizontal PDAF hardware unit 48, vertical PDAF hardware unit 50, or both horizontal PDAF hardware unit 48 and vertical PDAF hardware unit 50. In some examples, camera processor 14 may evaluate the long exposure of the camera image to determine whether PDAF hardware 47 is sufficient for processing the long exposure component. When the PDAF hardware 47 is not sufficient for processing the long exposure component, camera processor 14 may process the short exposure component using software (e.g., vertical PDAF software 54).

In some examples, to determine whether PDAF hardware 47 is sufficient for processing the long exposure component, camera processor 14 may determine whether a long exposure component including a region of interest (ROI) satisfies one or more criteria. For example, processor 14 may determine a confidence score corresponding to the ROI of the long exposure component and determine whether the confidence score of the ROI is greater than a threshold confidence score. When the confidence score of the ROI is greater than the threshold confidence score, camera processor 14 may determine that the ROI of the long exposure component satisfies the one or more criteria. When the confidence score of the ROI is greater than the threshold confidence score, camera processor 14 may determine that the ROI of the long exposure component does not satisfy the one or more criteria.

To determine whether PDAF hardware 47 is sufficient for processing the long exposure component, camera processor 14 may, in some examples, determine a level of exposure of the ROI of the long exposure component and determine whether the level of exposure of the ROI is greater than a threshold level of exposure. When the level of exposure of the ROI is greater than the threshold level of exposure, camera processor 14 may determine that the ROI of the long exposure component satisfies the one or more criteria. When the level of exposure of the ROI is not greater than the threshold level of exposure, camera processor 14 may determine that the ROI of the long exposure component does not satisfy the one or more criteria.

In any case when the long exposure component including the ROI does not satisfy the one or more criteria (e.g., when the ROI of the long exposure component does not have high confidence or when the ROI of the long exposure component is over exposed), camera processor 14 may process the short exposure component of the camera image with software. For example, when the ROI of the long exposure component does not satisfy the one or more criteria, camera processor 14 may process the short exposure component with software stored in system memory 30 (e.g., vertical PDAF software 54, model(s) 58, or other software stored in system memory 30).

By processing the short exposure component of the camera image with software only when the ROI of the long exposure component does not satisfy the one or more criteria, camera processor 14 may conserve computing resources and decrease processing latency as compared with systems that process both the long exposure component and the long exposure component in every case. Camera processor 14 may also ensure that camera images are processed sufficiently without using resources and taking extra time to process using software when software processing is not necessary.

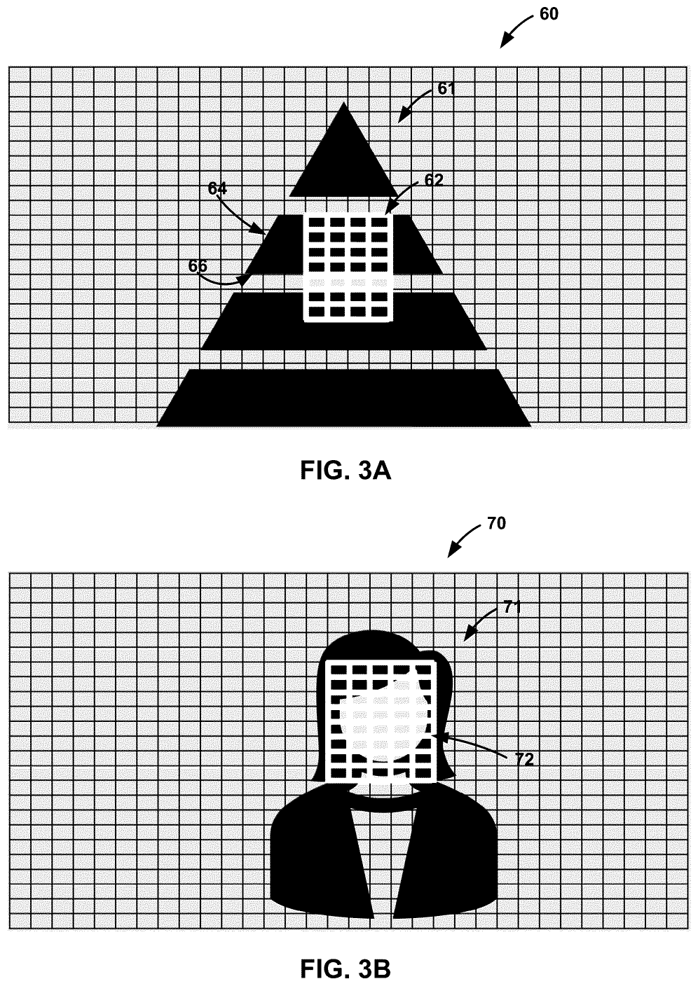

FIG. 3A is a conceptual diagram illustrating a first camera image 60 including a first object 61 and a first image region 62, in accordance with one or more techniques of this disclosure. As seen in FIG. 3A, first object 61 is a triangle-shaped object having a set of object sections arranged vertically on top of each other. For example, the set of object sections of first object 61 include one or more gaps between the set of object sections. The first object 61 is presented against a background. First camera image 60 includes one or more texture features corresponding to first object 61 and the background. For example, texture feature 64 includes a diagonal boundary between first object 61 and the background and texture feature 66 includes a horizontal boundary between first object 61 and the background. First object 61 may include one or more regions of first camera image 60 in which a texture of first camera image 60 results in inaccurate horizontal PDAF processing.

In some examples, first object 61 may be associated with a low horizontal PDAF confidence value. This is because there are horizontal texture features between first object 61 and the background including texture feature 66, which are difficult to process using horizontal PDAF. For example, when first image region 62 is shifted over by a pixel, texture feature 66 appears the same in the shifted region. This means that a minimum value of an SAD curve corresponding to first image region 62 might not be very different form an average value of an SAD curve corresponding to first image region 62, and therefore first image region 62 might be associated with a low horizontal PDAF confidence value.

Since texture feature 64 is diagonal and not horizontal, horizontal PDAF may be effective in processing portions of first image region 62 including diagonal texture features including texture feature 64. But since first object 61 includes several horizontal texture features including texture feature 66, first object 61 may in general be associated with low horizontal PDAF confidence. This means that it may be beneficial to process one or more regions of first camera image 60 using vertical PDAF (e.g., hardware PDAF and/or software PDAF) to more sufficiently bring horizontal texture features between first object 61 and the background into focus.

Hardware processing for vertical PDAF (e.g., using vertical PDAF hardware unit 50 of FIG. 2) may require significant area due to a line buffer requirement for registration. Strong horizontal binning may reduce data rate dramatically and apply a uniformity correction. It may be beneficial for camera system 10 to perform vertical processing in some regions (e.g., first image region 62) when horizontal PDAF confidence is low. A latency associated with several PDAF modalities is presented in the following table.

TABLE 1

| | Latency at 50% | |
|---|---|---|
| | Field of View (FOV) | |
| Horizontal Hardware PDAF | <1 | millisecond (ms) |
| +Software Vertical PDAF | 10 | ms |
| +Hardware accelerated Vertical PDAF | ~2 | ms |
| +On Demand Vertical PDAF | <1 | ms |

As seen in Table 1, processing a camera image using horizontal PDAF hardware unit 48 may take less time than using both horizontal PDAF hardware unit 48 and vertical PDAF software 54. Processing a camera image using horizontal PDAF hardware unit 48 may also take less time than using both horizontal PDAF hardware unit 48 and vertical PDAF hardware unit 50. But using on demand vertical PDAF to process regions of a camera image when horizontal PDAF is insufficient may take less time than using software and/or hardware vertical PDAF to process an entire image. This means that it may be beneficial to use vertical PDAF on-demand, when necessary, as a supplement to horizontal PDAF.

FIG. 3B is a conceptual diagram illustrating a second camera image 70 including a second object 71 and a second image region 72, in accordance with one or more techniques of this disclosure. As seen in FIG. 3B, second object 71 is a representation of an upper torso and a head of a human subject. Second image region 72 may be centered on a face of the human subject. In some examples, second image region 72 includes one or more curved texture features. These curved texture features include one or more curved texture features between a hairline of the human subject and a face of the subject and one or more curved texture features between a face of the patient and a neck of the patient. These curved texture features may include features that are aligned substantially vertically, features that are aligned substantially horizontally, and features that are aligned substantially diagonally.

In some examples, second image region 72 may be associated with a horizontal PDAF confidence that is higher than the horizontal PDAF confidence of first image region 62 of FIG. 3A. Although some texture features within second image region 72 (e.g., the chin of the human subject) may be more difficult to process using horizontal PDAF than other texture features, the features within second image region 72 are in general less horizontal than the features within first image region 62 of FIG. 3A. This means that horizontal PDAF may be more effective for processing second image region 72 as compared with an effectiveness of using horizontal PDAF to process first image region 62 of FIG. 3A. Consequently, it may be sufficient for camera system 10 to process second image region 72 using horizontal PDAF hardware unit 48 without using vertical PDAF.

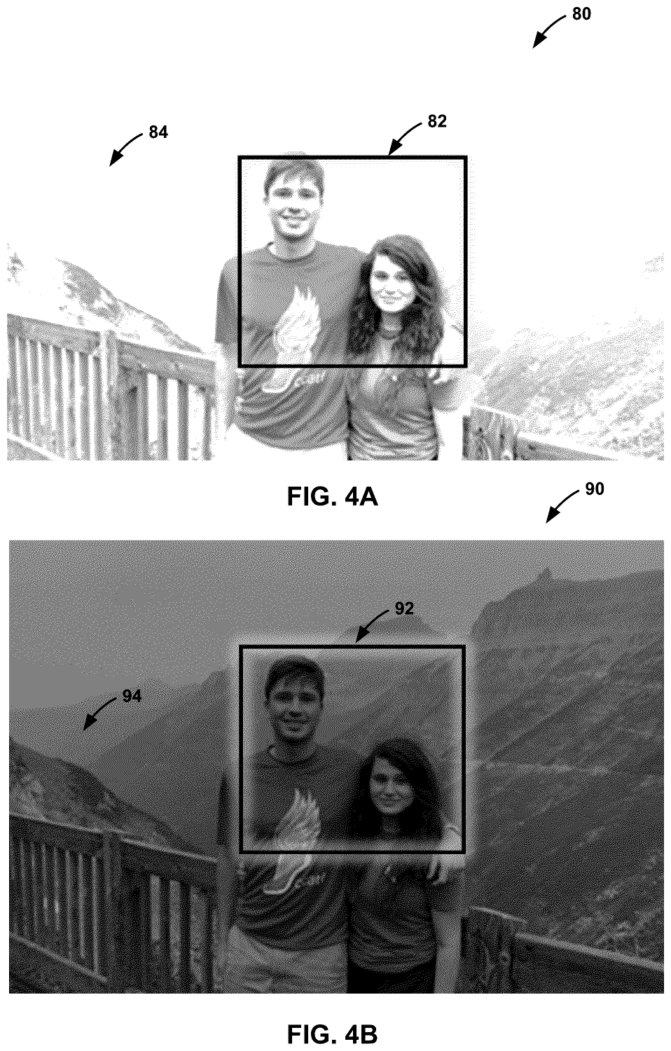

FIG. 4A is a conceptual diagram illustrating a long exposure component 80 of a camera image including an ROI 82, in accordance with one or more techniques of this disclosure. As seen in FIG. 4A, long exposure component 80 includes two human subjects featured in the ROI 82 against a background 84. Since the sensor that generated long exposure component 80 may be exposed to light for a greater amount of time as compared with a short exposure component, the background of long exposure component 80 may appear bright or completely white.

FIG. 4B is a conceptual diagram illustrating a short exposure component 90 of a camera image including an ROI 92, in accordance with one or more techniques of this disclosure. In some examples, short exposure component 90 and long exposure component 80 may represent components of the same camera image. As seen in FIG. 4B, short exposure component 90 includes two human subjects featured in the ROI 92 against a background 94. Since the sensor that generated short exposure component 90 may be exposed to light for a short amount of time as compared with a long exposure component 80, the background 94 and human subjects of short exposure component 90 may appear darker than the background 84 and human subjects of long exposure component 80.

Camera system 10 may use PDAF hardware 47 to process long exposure component 80. In some examples, when a PDAF confidence of long exposure component 80 is not greater than a confidence threshold, camera system 10 may use software stored by system memory 30 to process short exposure component 90. In some examples, when an exposure level of ROI 82 of long exposure component 80 is greater than a threshold level of exposure, camera system 10 may use software stored by system memory 30 to process short exposure component 90. In some examples, it may take a greater amount of computing resources and/or a greater amount of time to apply PDAF processing to both of long exposure component 80 and short exposure component 90 as compared with only applying PDAF processing to long exposure component 80. This means that it may be beneficial to use on-demand PDAF processing to apply PDAF processing to short exposure component 90, when necessary, but not when it is unnecessary to apply PDAF processing to short exposure component 90.

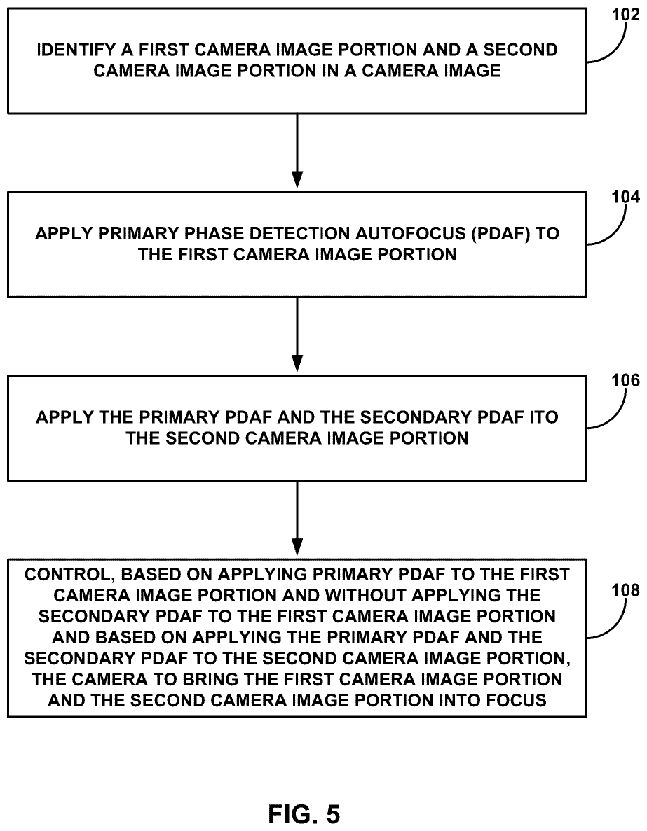

FIG. 5 is a flow diagram illustrating an example method for processing a camera image to focus a camera, in accordance with one or more techniques of this disclosure. FIG. 5 is described with respect to camera system 10, camera 12, camera processor 14, CPU 16, and system memory 30 of FIG. 1 and FIG. 2. However, the techniques of FIG. 5 may be performed by different components of camera system 10, camera 12, camera processor 14, CPU 16, and system memory 30, or by additional or alternative systems.

Camera processor 14 may identify, in a camera image, a first camera image portion and a second camera image portion (102). Camera processor 14 may apply primary PDAF to the first camera image portion (104). Camera processor 14 may apply the primary PDAF and secondary PDAF to the second camera image portion (106). In some examples, applying the primary PDAF is sufficient for controlling the camera to bring the first processed camera image portion into focus without applying the secondary PDAF. In some examples, applying the primary PDAF is not sufficient for controlling the camera to bring the second processed camera image portion into focus without applying the secondary PDAF. To determine whether applying primary PDAF is sufficient for controlling the camera to bring one or more portions of the camera image into focus, camera processor 14 may identify one or more confidence values corresponding to primary PDAF. In some cases, primary PDAF is sufficient for controlling the camera to bring both the first camera image portion and the second camera image portion into focus, and secondary PDAF is not necessary for bringing the first camera image portion and the second camera image portion into focus.

Camera processor 14 may control, based on applying primary PDAF to the first camera image portion and without applying the secondary PDAF to the first camera image portion and based on applying the primary PDAF and the secondary PDAF to the second camera image portion, the camera to bring the first camera image portion and the second camera image portion into focus (108). For example, camera processor 14 may control a position of lens 34 relative to a position of sensor 36 so that light rays refracted by lens 34 intersect with sensor 36 at a proper location. In some examples, it may be beneficial to use the secondary PDAF to process the second camera image portion so that camera processor 14 sufficiently brings the second camera image portion into focus. In some examples, it may be beneficial for camera processor 14 to use primary PDAF to process the first camera image portion without using secondary PDAF because primary PDAF is sufficient to bring the first camera image portion into focus without using secondary PDAF.

Additional aspects of the disclosure are detailed in numbered clauses below.

Clause 1—In one example, a system includes one or more memories configured to store a camera image captured with a camera; and processing circuitry in communication with the one or more memories. The processing circuitry is configured to identify, in the camera image, a first camera image portion and a second camera image portion, apply PDAF to the first camera image portion, and apply the primary PDAF and secondary PDAF to the second camera image portion. Additionally, the processing circuitry is configured to control, based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.

Clause 2—The system of Clause 1, wherein the camera image comprises a set of image regions, and wherein to identify the first camera image portion and a second camera image portion, the processing circuitry is configured to: determine a set of confidence scores, wherein each confidence score of the set of confidence scores corresponds to an image region of the set of image regions of the camera image; identify the first camera image portion to include each image region of the set of image regions corresponding to confidence scores greater than a threshold confidence score; and identify the second camera image portion to include each image region of the set of image regions corresponding to confidence scores not greater than the threshold confidence score.

Clause 3—The system of Clause 2, wherein to determine the set of confidence scores, the processing circuitry is configured to: identify, for each image region of the set of image regions corresponding to the camera image, an SAD curve based one or more pixel values corresponding to each pixel of the camera image, wherein the one or more pixel values comprise one or both of color values and intensity values; and determine each confidence score of the set of confidence scores based on the SAD curve corresponding to the respective image region.

Clause 4—The system of Clause 3, wherein to determine each confidence score of the set of confidence scores based on the SAD curve corresponding to the respective image region, the processing circuitry is configured to: identify a minimum value of the SAD curve corresponding to each image region of the set of image regions; calculate an average value of the SAD curve corresponding to each image region of the set of image regions; and calculate each confidence score of the set of confidence scores based on the minimum value of the SAD curve corresponding to the respective image region and based on the average value of the SAD curve corresponding to the respective image region.

Clause 5—The system of any of Clauses 1-5, wherein the primary PDAF comprises horizontal PDAF, and wherein the secondary PDAF comprises vertical PDAF.

Clause 6—The system of Clause 5, wherein the system further comprises a hardware unit, and wherein the processing circuitry is configured to: use the hardware unit to apply the horizontal PDAF to the first camera image portion; and use the hardware unit to apply the horizontal PDAF to the second camera image portion.

Clause 7—The system of Clause 6, wherein the one or more memories are further configured to store vertical PDAF software, and wherein the processing circuitry is further configured to execute the vertical PDAF software to apply the vertical PDAF to the second camera image portion.

Clause 8—The system of clause 7, wherein the one or more memories are further configured to store a vertical PDAF DNN, and wherein the processing circuitry is further configured to execute the vertical PDAF DNN to apply the vertical PDAF to the second camera image portion.

Clause 9—The system of any of Clauses 6-9, wherein the hardware unit is a first hardware unit, wherein the system further comprises a second hardware unit, and wherein the processing circuitry is further configured to use the second hardware unit to apply the vertical PDAF to the second camera image portion.

Clause 10—The system of any of Clauses 1-9, wherein the primary PDAF comprises hardware PDAF, wherein the secondary PDAF comprises software PDAF, wherein the camera image comprises a long exposure component and a short exposure component, wherein to identify the first camera image portion and a second camera image portion, the processing circuitry is configured to: determine whether an ROI of the long exposure component satisfies one or more criteria; identify the first camera image portion to include the long exposure component; and identify the second camera image portion to include the short exposure component corresponding to portions of the ROI of the long exposure component that do not satisfy the one or more criteria.

Clause 11—The system of Clause 10, wherein to determine whether the ROI of the long exposure component satisfies the one or more criteria, the processing circuitry is configured to: determine a confidence score of the ROI; and determine whether the confidence score of the ROI is greater than a threshold confidence score.

Clause 12—The system of any of Clauses 10-11, wherein to determine whether the ROI of the long exposure component satisfies the one or more criteria, the processing circuitry is configured to: determine a level of exposure of the ROI; and determine whether the level of exposure of the ROI is greater than a threshold level of exposure.

Clause 13—The system of any of Clauses 1-12, further comprising the camera, and wherein the processing circuitry is further configured to control the camera to capture the camera image.

Clause 14—A method includes identifying, in a camera image, a first camera image portion and a second camera image portion, applying PDAF to the first camera image portion, and applying the primary PDAF and secondary PDAF to the second camera image portion. The method also includes controlling, based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.

Clause 15—The method of clause 14, wherein the camera image comprises a set of image regions, and wherein identifying the first camera image portion and a second camera image portion comprises: determining a set of confidence scores, wherein each confidence score of the set of confidence scores corresponds to an image region of the set of image regions of the camera image; identifying the first camera image portion to include each image region of the set of image regions corresponding to confidence scores greater than a threshold confidence score; and identifying the second camera image portion to include each image region of the set of image regions corresponding to confidence scores not greater than the threshold confidence score.

Clause 16—The method of clause 15, wherein determining the set of confidence scores comprises: identifying, for each image region of the set of image regions corresponding to the camera image, an SAD curve based one or more pixel values corresponding to each pixel of the camera image, wherein the one or more pixel values comprise one or both of color values and intensity values; and determining each confidence score of the set of confidence scores based on the SAD curve corresponding to the respective image region.

Clause 17—The method of clause 16, wherein determining each confidence score of the set of confidence scores based on the SAD curve corresponding to the respective image region comprises: identifying a minimum value of the SAD curve corresponding to each image region of the set of image regions; calculating an average value of the SAD curve corresponding to each image region of the set of image regions; and calculating each confidence score of the set of confidence scores based on the minimum value of the SAD curve corresponding to the respective image region and based on the average value of the SAD curve corresponding to the respective image region.

Clause 18—The method of any of clauses 14-18, wherein the primary PDAF comprises horizontal PDAF, and wherein the secondary PDAF comprises vertical PDAF.

Clause 19—The method of clause 18, wherein the system further comprises a hardware unit, and wherein the method further comprises: using the hardware unit to apply the horizontal PDAF to the first camera image portion; and using the hardware unit to apply the horizontal PDAF to the second camera image portion.

Clause 20—The method of clause 19, wherein the one or more memories are further configured to store vertical PDAF software, and wherein the method further comprises executing the vertical PDAF software to apply the vertical PDAF to the second camera image portion.

Clause 21—The method of clause 20, wherein the one or more memories are further configured to store a vertical PDAF DNN, and wherein the method further comprises executing the vertical PDAF DNN to apply the vertical PDAF to the second camera image portion.

Clause 22—The method of any of clauses 19-21, wherein the hardware unit is a first hardware image processing unit, wherein the system further comprises a second hardware unit, and wherein the processing circuitry is further configured to use the second hardware unit to apply the vertical PDAF to the second camera image portion.

Clause 23—The method of any of clauses 14-21, wherein the primary PDAF comprises hardware PDAF, wherein the secondary PDAF comprises software PDAF, wherein the camera image comprises a long exposure component and a short exposure component, and wherein identifying the first camera image portion and a second camera image portion comprises: determining whether an ROI of the long exposure component satisfies one or more criteria; identifying the first camera image portion to include the long exposure component; and identifying the second camera image portion to include the short exposure component corresponding to portions of the ROI of the long exposure component that do not satisfy the one or more criteria.

Clause 24—The method of clause 23, wherein determining whether the ROI of the long exposure component satisfies the one or more criteria comprises: determining a confidence score of the ROI; and determining whether the confidence score of the ROI is greater than a threshold confidence score.

Clause 25—The method of any of clauses 23-24, wherein determining whether the ROI of the long exposure component satisfies the one or more criteria comprises: determining a level of exposure of the ROI; and determining whether the level of exposure of the ROI is greater than a threshold level of exposure.

Clause 26—The method of any of claims 14-24, further comprising the camera, and wherein the method further comprises controlling the camera to capture the camera image.

Clause 27—A computer-readable medium includes instructions that, when applied by processing circuitry, cause the processing circuitry to: identify, in a camera image, a first camera image portion and a second camera image portion, apply PDAF to the first camera image portion, and apply the primary PDAF and secondary PDAF to the second camera image portion; and The instructions also cause the processing circuitry to control. based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system comprising:
one or more memories configured to store a camera image captured with a camera; and
processing circuitry in communication with the one or more memories, wherein the processing circuitry is configured to:
identify, in the camera image, a first camera image portion and a second camera image portion;
apply primary phase detection autofocus (PDAF) to the first camera image portion;
apply the primary PDAF and secondary PDAF to the second camera image portion; and
control, based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.

2. The system of claim 1, wherein the camera image comprises a set of image regions, and wherein to identify the first camera image portion and a second camera image portion, the processing circuitry is configured to:
determine a set of confidence scores, wherein each confidence score of the set of confidence scores corresponds to an image region of the set of image regions of the camera image;
identify the first camera image portion to include each image region of the set of image regions corresponding to confidence scores greater than a threshold confidence score; and
identify the second camera image portion to include each image region of the set of image regions corresponding to confidence scores not greater than the threshold confidence score.

3. The system of claim 2, wherein to determine the set of confidence scores, the processing circuitry is configured to:
identify, for each image region of the set of image regions corresponding to the camera image, a sum of absolute differences (SAD) curve based one or more pixel values corresponding to each pixel of the camera image, wherein the one or more pixel values comprise one or both of color values and intensity values; and
determine each confidence score of the set of confidence scores based on the SAD curve corresponding to the respective image region.

4. The system of claim 3, wherein to determine each confidence score of the set of confidence scores based on the SAD curve corresponding to the respective image region, the processing circuitry is configured to:
identify a minimum value of the SAD curve corresponding to each image region of the set of image regions;
calculate an average value of the SAD curve corresponding to each image region of the set of image regions; and
calculate each confidence score of the set of confidence scores based on the minimum value of the SAD curve corresponding to the respective image region and based on the average value of the SAD curve corresponding to the respective image region.

5. The system of claim 1, wherein the primary PDAF comprises horizontal PDAF, and wherein the secondary PDAF comprises vertical PDAF.

6. The system of claim 5, wherein the system further comprises a hardware unit, and wherein the processing circuitry is configured to:
use the hardware unit to apply the horizontal PDAF to the first camera image portion; and
use the hardware unit to apply the horizontal PDAF to the second camera image portion.

7. The system of claim 6, wherein the one or more memories are further configured to store vertical PDAF software, and wherein the processing circuitry is further configured to execute the vertical PDAF software to apply the vertical PDAF to the second camera image portion.

8. The system of claim 7, wherein the one or more memories are further configured to store a vertical PDAF deep neural network (DNN), and wherein the processing circuitry is further configured to execute the vertical PDAF DNN to apply the vertical PDAF to the second camera image portion.

9. The system of claim 6, wherein the hardware unit is a first hardware unit, wherein the system further comprises a second hardware unit, and wherein the processing circuitry is further configured to use the second hardware unit to apply the vertical PDAF to the second camera image portion.

10. The system of claim 1, wherein the primary PDAF comprises hardware PDAF, wherein the secondary PDAF comprises software PDAF, wherein the camera image comprises a long exposure component and a short exposure component, wherein to identify the first camera image portion and a second camera image portion, the processing circuitry is configured to:
determine whether the long exposure component including a region of interest (ROI) satisfies one or more criteria;
identify the first camera image portion to include the long exposure component; and
identify the second camera image portion to include the short exposure component corresponding to portions of the ROI of the long exposure component that do not satisfy the one or more criteria.

11. The system of claim 10, wherein to determine whether the long exposure component including the ROI satisfies the one or more criteria, the processing circuitry is configured to:
determine a confidence score of the ROI; and
determine whether the confidence score of the ROI is greater than a threshold confidence score.

12. The system of claim 10, wherein to determine whether the long exposure component including the ROI satisfies the one or more criteria, the processing circuitry is configured to:
determine a level of exposure of the ROI; and
determine whether the level of exposure of the ROI is greater than a threshold level of exposure.

13. The system of claim 1, further comprising the camera, and wherein the processing circuitry is further configured to control the camera to capture the camera image.

14. A method comprising:
identifying, in a camera image, a first camera image portion and a second camera image portion;
applying primary phase detection autofocus (PDAF) to the first camera image portion;
applying the primary PDAF and secondary PDAF to the second camera image portion; and
controlling, based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.

15. The method of claim 14, wherein the camera image comprises a set of image regions, and wherein identifying the first camera image portion and a second camera image portion comprises:
determining a set of confidence scores, wherein each confidence score of the set of confidence scores corresponds to an image region of the set of image regions of the camera image;
identifying the first camera image portion to include each image region of the set of image regions corresponding to confidence scores greater than a threshold confidence score; and
identifying the second camera image portion to include each image region of the set of image regions corresponding to confidence scores not greater than the threshold confidence score.

16. The method of claim 15, wherein determining the set of confidence scores comprises:
identifying, for each image region of the set of image regions corresponding to the camera image, a sum of absolute differences (SAD) curve based one or more pixel values corresponding to each pixel of the camera image, wherein the one or more pixel values comprise one or both of color values and intensity values; and
determining each confidence score of the set of confidence scores based on the SAD curve corresponding to the respective image region.

17. The method of claim 16, wherein determining each confidence score of the set of confidence scores based on the SAD curve corresponding to the respective image region comprises:
identifying a minimum value of the SAD curve corresponding to each image region of the set of image regions;
calculating an average value of the SAD curve corresponding to each image region of the set of image regions; and
calculating each confidence score of the set of confidence scores based on the minimum value of the SAD curve corresponding to the respective image region and based on the average value of the SAD curve corresponding to the respective image region.

18. The method of claim 14, wherein the primary PDAF comprises horizontal PDAF, and wherein the secondary PDAF comprises vertical PDAF.

19. The method of claim 18, wherein the system further comprises a hardware unit, and wherein the method further comprises:
using the hardware unit to apply the horizontal PDAF to the first camera image portion; and
using the hardware unit to apply the horizontal PDAF to the second camera image portion.

20. The method of claim 19, wherein the one or more memories are further configured to store vertical PDAF software, and wherein the method further comprises executing the vertical PDAF software to apply the vertical PDAF to the second camera image portion.

21. The method of claim 20, wherein the one or more memories are further configured to store a vertical PDAF deep neural network (DNN), and wherein the method further comprises executing the vertical PDAF DNN to apply the vertical PDAF to the second camera image portion.

22. The method of claim 19, wherein the hardware unit is a first hardware image processing unit, wherein the system further comprises a second hardware unit, and wherein the processing circuitry is further configured to use the second hardware unit to apply the vertical PDAF to the second camera image portion.

23. The method of claim 14, wherein the primary PDAF comprises hardware PDAF, wherein the secondary PDAF comprises software PDAF, wherein the camera image comprises a long exposure component and a short exposure component, and wherein identifying the first camera image portion and a second camera image portion comprises:
determining whether a long exposure component including a region of interest (ROI) satisfies one or more criteria;
identifying the first camera image portion to include the long exposure component; and
identifying the second camera image portion to include the short exposure component corresponding to portions of the ROI of the long exposure component that do not satisfy the one or more criteria.

24. The method of claim 23, wherein determining whether the long exposure component including the ROI satisfies the one or more criteria comprises:
determining a confidence score of the ROI; and
determining whether the confidence score of the ROI is greater than a threshold confidence score.

25. The method of claim 23, wherein determining whether the long exposure component including the ROI satisfies the one or more criteria comprises:
determining a level of exposure of the ROI; and
determining whether the level of exposure of the ROI is greater than a threshold level of exposure.

26. The method of claim 14, further comprising the camera, and wherein the method further comprises controlling the camera to capture the camera image.

27. A computer-readable medium storing instructions that, when applied by processing circuitry, causes the processing circuitry to:
identify, in a camera image, a first camera image portion and a second camera image portion;
apply primary phase detection autofocus (PDAF) to the first camera image portion;
apply the primary PDAF and secondary PDAF to the second camera image portion; and
control, based on applying the primary PDAF to the first camera image portion and without applying the secondary PDAF to the first camera image portion and based on applying the primary PDAF and the secondary PDAF to the second camera image portion, the camera to bring the first camera image portion and the second camera image portion into focus.
